(19) United States
(12) Patent Application Publication
(10) Pub. No.: US 2025/0224545 A1
(43) Pub. Date: Jul. 10, 2025

(54) PRISM SHEET AND ACTIVE ENERGY RAY CURING COMPOSITION FOR PRISM SHEET

(71) Applicant: DIC Corporation, Tokyo (JP)

(72) Inventors: Yuki Kinoshita, Ichihara-shi (JP); Yujiro Hara, Ichihara-shi (JP); Masakazu Yoshizawa, Ichihara-shi (JP); Dongmi Shin, Ichihara-shi (JP); Yutaro Ueda, Ichihara-shi (JP); Yasuhiro Takada, Ichihara-shi (JP); Yoshinobu Deguchi, Ichihara-shi (JP)

(73) Assignee: DIC Corporation, Tokyo (JP)

(21) Appl. No.: 18/853,559

(22) PCT Filed: Apr. 18, 2023
(86) PCT No.: PCT/JP2023/015447

§ 371 Date: Oct. 2, 2024

(30) Foreign Application Priority Data
Apr. 27, 2022 (JP) 2022-073693

(51) Int. Cl. G02B 5/04; C08K 3/22; G02B 1/04

(52) U.S. Cl. CPC G02B 5/045; C08K 3/22; G02B 1/04; C08K 2003/2244; C08K 2201/011

(57) ABSTRACT

According to the present invention, both good abrasion resistance and a high refractive index can be achieved with a material having a certain parameter, as evaluated using a flat indenter to evaluate mechanical properties of a convex portion of a prism sheet. The prism sheet of the present invention includes a micro concave-convex structure layer which is a cured product of an active energy ray curing composition containing 40 mass % or more of inorganic nanoparticles, and a transparent substrate layer. The micro concave-convex structure layer has a micro concave-convex structure with a period of 20 μm to 100 μm on a surface thereof. The micro concave-convex structure layer has an indentation depth (hmax) of 8 μm or more at a maximum test force and an elastic deformation power (nIT) of 50% or more.

### TECHNICAL FIELD

The present invention relates to a prism sheet used for a display such as a liquid crystal display device, and an active energy ray curing composition for a prism sheet. The present application claims priority benefit of Japanese Patent Application No. 2022-073693, filed on Apr. 27, 2022, the entire contents of which are incorporated herein by reference.

### BACKGROUND ART

In recent years, an optical sheet having functions such as improving brightness and widening a viewing angle has been used in a display such as a liquid crystal display device. Such an optical sheet generally includes a substrate and an optical function layer having a micro concave-convex structure on the substrate, and exhibits a desired function by modulating light in a concave-convex shape thereof through a geometric optical action such as refraction. Since such a concave-convex shape is formed mainly by a method of shaping a resin material using a mold, a material used for the optical function layer is required to contain no solvent and have low viscosity.

In addition, among the optical sheet, for example, a prism sheet has a sharp convex shape and is therefore prone to chipping due to friction with adjacent members. In the case of such a prism sheet, abrasion resistance is particularly required.

On the other hand, with a reduction in thickness of a display, a reduction in power consumption, and the like, a material used for the optical function layer is required to have a high refractive index. In order to cope with this, a method of using a resin having a high refractive index or adding organic or inorganic high-refractive-index fine particles has been proposed (for example, PTLs 1 and 2).

### CITATION LIST

### Patent Literature

PTL 1: WO2020/250721
PTL 2: JP2013-249439A

### SUMMARY OF INVENTION

### Technical Problem

However, since a material having a high refractive index generally decreases flexibility of a resin cured product, there is a problem that chipping of a concave-convex shape may be likely to occur. Accordingly, a material having good abrasion resistance and a high refractive index has been required.

The present invention has been made to solve the above problems, and an object is to achieve both good abrasion resistance and a high refractive index with a material having a certain parameter, as evaluated using a flat indenter to evaluate mechanical properties of a convex portion of a prism sheet.

### Solution to Problem

The content of the present disclosure includes the following embodiments.

[1] A prism sheet including:
a micro concave-convex structure layer which is a cured product of an active energy ray curing composition; and
a transparent substrate layer, in which
the active energy ray curing composition contains 40 mass % or more of inorganic nanoparticles,
the micro concave-convex structure layer has a micro concave-convex structure with a period of 10 μm to 100 μm on a surface,
the micro concave-convex structure layer has an indentation depth (hmax) of 8 μm or more at a maximum test force and an elastic deformation power (nIT) of 50% or more, and
the indentation depth (hmax) at the maximum test force and the elastic deformation power (nIT) are obtained under the following measurement conditions:
indenter: 100 μm×100 μm flat indenter
compressive force per second of flat indenter: 20 mN to 60 mN
maximum compressive force: 500 mN
stop time at maximum compressive force: 5 seconds to 10 seconds.

[2] The prism sheet according to [1], in which
a maximum point displacement is 2.1% or more in a tearing test of a test piece formed of the cured product of the active energy ray curing composition, and
the tearing test is performed according to JIS-K-7128-3 under the following measurement conditions:
shape of the test piece: a right-angle tearing test piece according to JIS-K-7128-3
thickness of the test piece: 200 μm±50 μm (value measured for each test piece)
preparation of the test piece: prepared by punching
distance between grips: 56 mm
test environment: 23° C.×50% RH
test speed: 500 mm/min.

[3] The prism sheet according to [1] or [2], in which
the inorganic nanoparticles are zirconia.

[4] The prism sheet according to any one of [1] to [3], in which
the active energy ray curing composition contains a (meth)acrylate compound.

[5] The prism sheet according to any one of [1] to [4], in which
the active energy ray curing composition contains a surface conditioner in a range of 0.1 parts by mass to 1.5 parts by mass in the composition.

[6] The prism sheet according to [5], in which
the surface conditioner contains silicon.

[7] An active energy ray curing composition for a prism sheet, the composition containing:
inorganic nanoparticles; and
a (meth)acrylate compound, in which
the active energy ray curing composition for a prism sheet contains 40 mass % or more of the inorganic nanoparticles,
a standard prism sheet made of a cured product of the active energy ray curing composition for a prism sheet has an indentation depth (hmax) of 8 μm or more at a maximum test force and an elastic deformation power (nIT) of 50% or more,
the standard prism sheet includes a transparent substrate layer and a micro concave-convex structure layer,
the transparent substrate layer is polyethylene terephthalate having a thickness of 125 μm,
the micro concave-convex structure layer has a micro concave-convex structure with a period of 50 μm on a surface of the transparent substrate layer, a unit structure of the micro concave-convex structure constitutes a unit prism, and a shape of the unit prism is an isosceles triangular prism shape having a height of 25 μm, a base of 50 μm, and an apex angle of 90° in a cross section in a thickness direction,
for the unit prism, a large number of plurality of unit prisms are adjacently arranged with an array period of 50 μm in a direction perpendicular to ridge lines such that the ridge lines of the respective unit prisms are balanced with each other in a plan view of the prism sheet, and
the indentation depth (hmax) at the maximum test force and the elastic deformation power (nIT) are obtained under the following measurement conditions:
indenter: 100 μm×100 μm flat indenter
compressive force per second of flat indenter: 20 mN to 60 mN
maximum compressive force: 500 mN
stop time at maximum compressive force: 5 seconds to 10 seconds.

[8] The active energy ray curing composition for a prism sheet according to [7], in which
a maximum point displacement is 2.1% or more in a tearing test of a test piece formed of a cured product of the active energy ray curing composition for a prism sheet, and
the tearing test is performed according to JIS-K-7128-3 under the following measurement conditions:
shape of the test piece: a right-angle tearing test piece according to JIS-K-7128-3
thickness of the test piece: 200 μm±50 μm (value measured for each test piece)
preparation of the test piece: prepared by punching
distance between grips: 56 mm
test environment: 23° C.×50% RH
test speed: 500 mm/min.

[9] The active energy ray curing composition for a prism sheet according to [7] or [8], in which
the inorganic nanoparticles are zirconia.

[10] The active energy ray curing composition for a prism sheet according to any one of [7] to [9], further containing:
a surface conditioner in a range of 0.1 parts by mass to 1.5 parts by mass.

### Advantageous Effects of Invention

According to the present invention, both good abrasion resistance and a high refractive index can be achieved with a material having a certain parameter, as evaluated using a flat indenter to evaluate mechanical properties of a convex portion of a prism sheet.

### BRIEF DESCRIPTION OF DRAWINGS

FIG. 1 is a schematic perspective view of an example of a prism sheet of the present embodiment.

FIG. 2 is a schematic cross-sectional view of an example of the prism sheet according to the present embodiment.

FIG. 3 is a schematic cross-sectional view of an example of a surface of the prism sheet according to the present embodiment.

FIG. 4 is a cross-sectional view of a flat indenter used in an indentation test method according to the present embodiment.

FIG. 5 is a schematic view showing the indentation test method using the flat indenter according to the present embodiment.

FIG. 6 is a schematic view illustrating a measurement position of the flat indenter in an indentation test according to the present embodiment.

### DESCRIPTION OF EMBODIMENTS

Hereinafter, the present invention will be described in more detail. It should be noted that the present invention is not limited to the following embodiment.

The term “to” means that a value is equal to or greater than a value before the term “to”, and is equal to or less than a value after the term “to”. The term “(meth)acrylic” is a general term for acrylic and methacrylic, and the term “(meth)acrylate compound” is a general term for acrylic resin and methacrylic resin.

### (Prism Sheet)

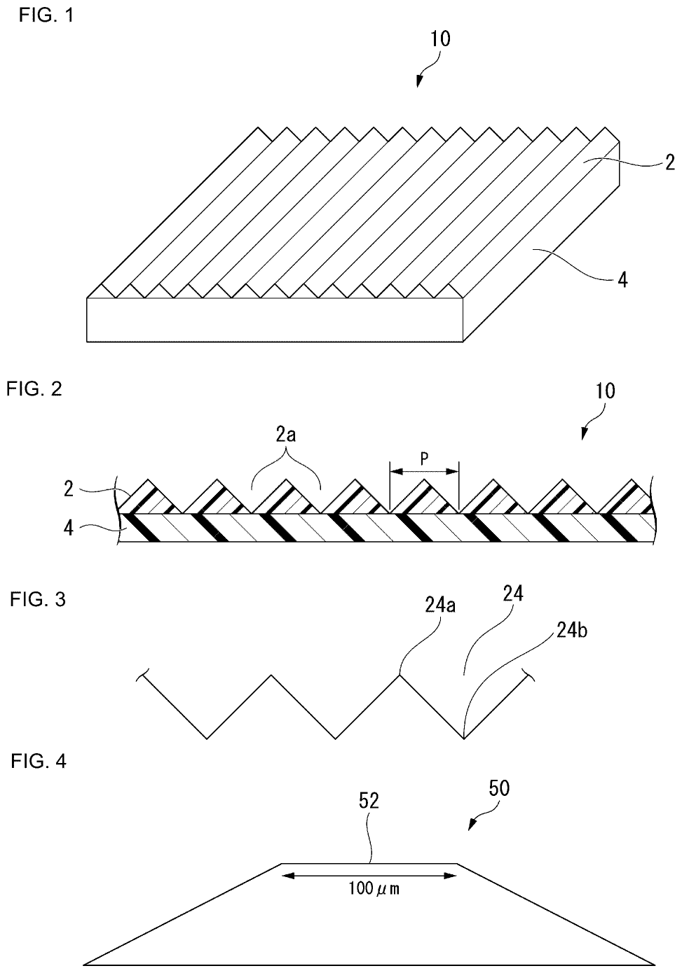

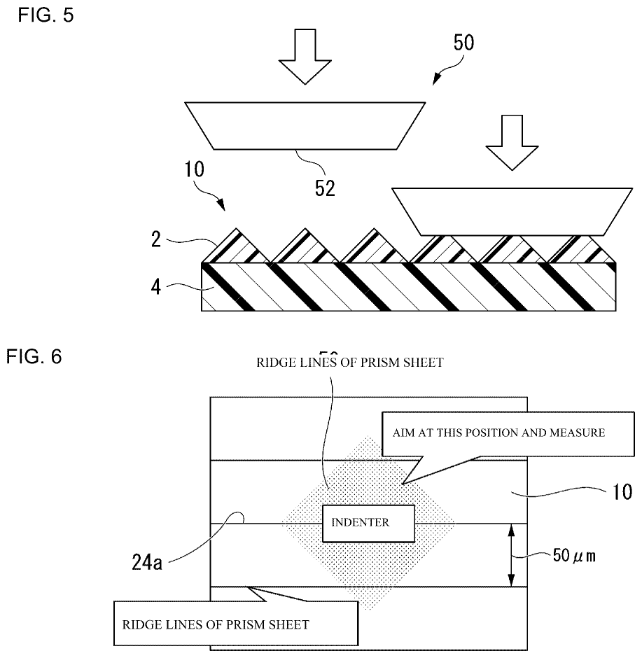

FIG. 1 is a schematic perspective view showing an example of a prism sheet 10 of the present embodiment. FIG. 2 is a schematic cross-sectional view of an example of the prism sheet 10 according to the present embodiment. The prism sheet 10 of the present embodiment includes a micro concave-convex structure layer which is a cured product of an active energy ray curing composition, and a transparent substrate layer. The active energy ray curing composition contains 40 mass % or more of inorganic nanoparticles. In addition, the micro concave-convex structure layer has a micro concave-convex structure 2a with a period P of 10 μm to 100 μm on a surface thereof.

In an indentation test using a flat indenter for a surface having the micro concave-convex structure 2a of the prism sheet 10 of the present embodiment, an indentation depth (hmax) at a maximum test force is 8 μm or more, preferably 8.5 μm or more and 15 μm or less, and more preferably 9 μm or more and 12 μm or less. In addition, an elastic deformation power (nIT) is 50% or more, preferably 51% or more, and more preferably 55% or more. In addition, an upper limit of the elastic deformation power (nIT) is not particularly limited, and a higher value is preferred. In other words, from the viewpoint of a balance with a refractive index, the elastic deformation power (nIT) is preferably 51% or more and 70% or less, and more preferably 55% or more and 65% or less.

It should be noted that the indentation depth (hmax) at the maximum test force and the elastic deformation power (nIT) are obtained under the following measurement conditions:
indenter: 100 μm×100 μm flat indenter
compressive force per second of flat indenter: 20 mN to 60 mN
maximum compressive force: 500 mN
stop time at maximum compressive force: 5 seconds to 10 seconds.
The indentation test will be described in detail in Examples.

The prism sheet 10 preferably includes a micro concave-convex structure layer 2 and a transparent substrate layer 4.

### [Micro Concave-Convex Structure Layer]

As an example of the micro concave-convex structure layer 2 of the present embodiment, as shown in FIGS. 1 and 2, a plurality of triangular pyramidal unit concave-convex structures 2a are two-dimensionally arranged on a surface of the transparent substrate layer 4, but the present invention is not limited thereto. For example, the micro concave-convex structure layer 2 of the present embodiment may be a layer in which a plurality of unit concave-convex structures 2a such as cones, truncated cones, or pyramids or truncated pyramids of triangles, squares, pentagons, hexagons, and the like are two-dimensionally arranged on a surface of a transparent substrate layer.

A cross-sectional shape of a unit prism in a normal direction of a plane of the transparent substrate layer (hereinafter, simply referred to as a “thickness direction”) may be an isosceles triangular shape as shown in FIG. 3, or may be an irregular triangular shape (not shown).

A value of an apex angle 24a of the triangular unit prism in the cross section in the thickness direction may be 90° as shown in FIG. 3, or may be another angle, and can be adjusted within a range of 40° to 120°. A value of a bottom angle 24b may be 90° as shown in FIG. 3, or may be another angle, and can be adjusted within a range of 40° to 120°.

The thickness of the micro concave-convex structure layer 2 of the present embodiment is preferably 5 μm to 100 μm, more preferably 5 μm to 60 μm, and still more preferably 10 μm to 40 μm.

### <Active Energy Ray Curing Composition>

In a tearing test of a test piece made of the cured product of the active energy ray curing composition according to the present embodiment, a maximum point displacement is preferably 2.1% or more, more preferably 2.5% or more, and still more preferably 3.1% or more. The maximum point displacement is preferably 20% or less. When the maximum point displacement is 2.1% or more, abrasion resistance is excellent. When the maximum point displacement is 20% or less, a practical sufficient effect can be obtained.

It should be noted that the tearing test is performed according to JIS-K-7128-3 under the following measurement conditions:
shape of the test piece: a right-angle tearing test piece according to JIS-K-7128-3
thickness of the test piece: 200 μm±50 μm (value measured for each test piece)
preparation of the test piece: prepared by punching
distance between grips: 56 mm
test environment: 23° C.×50% RH
test speed: 500 mm/min.
The test will be described in detail in Examples.

The active energy ray curing composition according to the present embodiment preferably contains a (meth)acrylate compound. The inorganic nanoparticles contained in the active energy ray curing composition according to the present embodiment are more preferably zirconia fine particles (hereinafter, simply referred to as zirconia).

The active energy ray curing composition containing the zirconia and the (meth)acrylate compound is referred to as an “active energy ray curing composition for a prism sheet”. In this case, a standard prism sheet made of the cured product of the active energy ray curing composition for a prism sheet has an indentation depth (hmax) of 8 μm or more, preferably 8.5 μm or more and 15 μm or less, and more preferably 9 μm or more and 12 μm or less at a maximum test force. In addition, an elastic deformation power (nIT) is 50% or more, preferably 51% or more and 70% or less, and more preferably 55% or more and 65% or less.

It should be noted that the standard prism sheet for evaluating the indentation depth includes a transparent substrate layer and a micro concave-convex structure layer, the transparent substrate layer is polyethylene terephthalate having a thickness of 125 μm, the micro concave-convex structure layer has a micro concave-convex structure with a period of 50 μm on a surface of the transparent substrate layer, a unit structure of the micro concave-convex structure constitutes a unit prism, a shape of the unit prism is an isosceles triangular prism shape having a height of 25 μm, a base of 50 μm, and an apex angle of 90° in a cross section in a thickness direction.

For the unit prism, a large number of plurality of unit prisms are adjacently arranged with an array period of 50 μm in a direction perpendicular to ridge lines such that the ridge lines of the respective unit prisms are balanced with each other in a plan view of the prism sheet.

Measurement conditions of the indentation depth (hmax) at the maximum test force and the elastic deformation power (nIT) are the same as the measurement conditions described in the prism sheet of the present embodiment.

In addition, a method for producing a standard prism sheet by curing the active energy ray curing composition for a prism sheet is the same as the method for producing an active energy ray curing composition P1 obtained in Preparation Example in Example 1 to be described later.

In the present embodiment, the term “active energy ray” includes not only an electromagnetic wave having a wavelength in a non-visible region, such as a visible ray, an ultraviolet ray, and an X-ray, but also a radiant ray, which is a general term for particle rays such as an electron ray and an α-ray. The radiant ray has an energy quantum sufficient to cause a crosslinking reaction or a polymerization reaction in a molecule having an active energy ray curing group. The active energy ray is preferably an ultraviolet ray.

### [Zirconia]

As the zirconia according to the present embodiment, generally well-known zirconia can be used, and a particle shape is not particularly limited. Examples thereof include a spherical shape, a hollow shape, a porous shape, a rod shape, and a fibrous shape. Among them, a spherical shape is preferred.

In addition, the average primary particle diameter of the zirconia according to the present embodiment is preferably 1 nm to 50 nm, and more preferably 1 nm to 30 nm. Further, a crystal structure is not particularly limited, and a monoclinic system is preferred.

The average primary particle diameter in the present invention can be measured by a method of directly measuring a size of a primary particle from an electron microscopic photograph using a transmission electron microscope (TEM). Examples of the measurement method include a method in which the minor axis diameter and the major axis diameter of primary particles of the individual inorganic fine particles are measured, and an average thereof is used as the average primary particle diameter of the primary particles.

Specific examples of the zirconia according to the present embodiment include UEP-100 (manufactured by Daiichi Kigenso Kagaku Kogyo Co., Ltd., average primary particle diameter: 11 nm) and PCS (manufactured by Nitto Denko Co., Ltd., average primary particle diameter: 20 nm).

The content of zirconia according to the present embodiment in the active energy ray curing composition is preferably 40 mass % to 90 mass %, more preferably 40 mass % to 80 mass %, and still more preferably 40 mass % to 70 mass %.

### [(Meth)Acrylate Compound]

As the (meth)acrylate compound according to the present embodiment, related art well-known monofunctional (meth)acrylates or polyfunctional (meth)acrylates having a (meth)acryloyl group or a (meth)acryloyloxy group, that form a prism sheet, can be used. If necessary, an oligomer, a prepolymer, or the like can be used.

Examples of the monofunctional (meth)acrylate include a vinyl monomer, a (meth)acrylic acid ester monomer, and a (meth)acrylamide derivative described in Patent Literature (JP2009-37204A).

Examples of the polyfunctional (meth)acrylate include a difunctional (meth)acrylate and a trifunctional (meth)acrylate. Examples thereof include ethylene glycol di(meth)acrylate, bisphenol A polyethoxydiol di(meth)acrylate, and pentaerythritol tri(meth)acrylate described in Patent Literature (JP2009-37204A).

Examples of a reactive prepolymer include an epoxy (meth)acrylate, a urethane (meth)acrylate, and a polyester (meth)acrylate described in Patent Literature (JP2009-37204A).

In a preferred aspect of the prism sheet according to the present embodiment, the (meth)acrylate compound preferably contains (A) a monofunctional (meth)acrylate having one active energy ray curing group (hereinafter, also simply referred to as “component (A)”) and (B) a difunctional (meth)acrylate and/or a trifunctional (meth)acrylate having two active energy ray curing groups (hereinafter, also simply referred to as “component (B)”). The (meth)acrylate compound more preferably contains the component (A), the component (B), and (C) an initiator (hereinafter, simply referred to as “component (C)”). The (meth)acrylate compound further more preferably contains the component (A), the component (B), the component (C), and (D) a surface conditioner (hereinafter, simply referred to as “component (D)”). The total mass of the (A) and (B) is preferably 50 mass % or less based on the total solid content mass of the active energy ray curing resin composition. This is because, in this case, the micro concave-convex structure layer can have a high refractive index while exhibiting the indentation depth in the above-described specific range and the above-described specific restoring property.

Hereinafter, the components (A) to (D) will be described in order.

### (Component (A))

The component (A) is a monofunctional (meth)acrylate having one active energy ray curing group. The monofunctional (meth)acrylate may contain a heteroatom such as a halogen atom, a sulfur atom, an oxygen atom, or a nitrogen atom. The monofunctional (meth)acrylate may be a chain aliphatic (meth)acrylate, a cyclic alicyclic (meth)acrylate, or an aromatic (meth)acrylate. For example, a monofunctional (meth)acrylate described in PTL 1 described above can be used.

Examples of the component (A) include monofunctional (meth)acrylates such as n-butyl (meth)acrylate, isobutyl (meth)acrylate, tert-butyl (meth)acrylate, n-pentyl (meth)acrylate, n-hexyl (meth)acrylate, n-octyl (meth)acrylate, isooctyl (meth)acrylate, 2-ethylhexyl (meth)acrylate, benzyl (meth)acrylate, phenylbenzyl (meth)acrylate, a phenylphenol (EO)ₙ (meth)acrylate, a phenol (EO)ₙ (meth)acrylate, phenoxybenzyl (meth)acrylate, biphenylmethyl (meth)acrylate, phenoxyethyl (meth)acrylate, glycidyl (meth)acrylate, morpholine (meth)acrylate, 2-hydroxyethyl (meth)acrylate, 2-hydroxypropyl (meth)acrylate, 4-hydroxybutyl (meth)acrylate, 2-methoxyethyl (meth)acrylate, tetrahydrofurfuryl (meth)acrylate, caprolactone-modified tetrahydrofurfuryl (meth)acrylate, cyclohexyl (meth)acrylate, isobornyl (meth)acrylate, 2-hydroxy-3-phenoxypropyl (meth)acrylate, cyclohexylmethyl (meth)acrylate, cyclohexylethyl (meth)acrylate, dicyclopentanyl (meth)acrylate, dicyclopentanyloxyethyl (meth)acrylate, dicyclopentenyl (meth)acrylate, and dicyclopentenyloxyethyl (meth)acrylate.

Specific examples of the component (A) include the following monofunctional (meth)acrylate-1 to monofunctional (meth)acrylate-6 used in Examples.
Monofunctional (meth)acrylate-1: KOMERATE A011 (manufactured by Green Chemical Co., Ltd.)
Structural formula or compound name: orthophenylphenol (EO) acrylate
Monofunctional (meth)acrylate-2: Photomer 4035 (manufactured by IGM Resins Inc.)
Structural formula or compound name: phenol (EO) acrylate
Monofunctional (meth)acrylate-3: KOMERATE A008 (manufactured by Green Chemical Co., Ltd.)
Structural formula or compound name: 3-phenoxybenzyl acrylate
Monofunctional (meth)acrylate-4: MIRAMER M1192 (manufactured by MIWON SPECIALTY CHEMICAL CO., LTD.)
Structural formula or compound name: biphenyl methyl acrylate
Monofunctional (meth)acrylate-5: MIRAMER M142 (manufactured by MIWON SPECIALTY CHEMICAL CO., LTD.)
Structural formula or compound name: phenol (EO)₂ acrylate
Monofunctional (meth)acrylate-6: MIRAMER M144 (manufactured by MIWON SPECIALTY CHEMICAL CO., LTD.)
Structural formula or compound name: phenol (EO)₄ acrylate

The component (A) may be used alone or in combination of two or more thereof.

The content of the component (A) is preferably 20 mass % to 50 mass % based on the total solid content mass of the composition. Then, the content of an aromatic ring-containing acrylate is preferably 15 mass % to 30 mass %, and more preferably 22 mass % to 27 mass %, based on the total solid content mass of the composition.

In addition, the content of a compound represented by the above-described general formula (2) is preferably 5 mass % to 20 mass %, and more preferably 5 mass % to 15 mass %, based on the total solid content mass of the composition.

The total mass ((A)+(B)) of the component (A) and the component (B) to be described later is preferably 50 mass % or less, and more preferably 10 to 40 mass %, based on the total solid content mass of the composition. By setting the total mass to 50 mass % or less based on the total solid content mass of the composition, the micro concave-convex structure layer can have a high refractive index while exhibiting the indentation depth in the above-described specific range and the above-described specific restoring property.

### (Component (B))

The component (B) is a polyfunctional (meth)acrylate having two or more active energy ray curing groups. The component (B) may be a chain aliphatic or cyclic alicyclic or aromatic (meth)acrylic acrylate containing a heteroatom such as a halogen atom, a sulfur atom, an oxygen atom, or a nitrogen atom. For example, a polyfunctional (meth)acrylate described in the above-described PTL 1 can be used.

Examples of the component (B) include polyfunctional (meth)acrylates such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, butylene glycol di(meth)acrylate, tetrabutylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dicyclopentanyl di(meth)acrylate, glycerol di(meth)acrylate, neopentyl glycol hydroxypivalic acid ester di(meth)acrylate, caprolactone modified hydroxypivalic acid neopentyl glycol di(meth)acrylate, tetrabromobisphenol A di(meth)acrylate, hydropivalaldehyde modified trimethylolpropane di(meth)acrylate, bisphenol fluorene di(meth)acrylate, a bisphenol fluorene (EO)ₙ di(meth)acrylate, a bisphenol A (EO)ₙ di(meth)acrylate, a trimethylolpropane (EO)ₙ tri(meth)acrylate, 1,4-cyclohexanedimethanol di(meth)acrylate, trimethylolpropane tri(meth)acrylate, pentaerythritol tri(meth)acrylate, glycerol tri(meth)acrylate, alkyl modified dipentaerythritol tri(meth)acrylate, ditrimethylolpropane tetra(meth)acrylate, epoxy (meth)acrylate, urethane (meth)acrylate, and polyester (meth)acrylate.

Specific examples of the component (B) include a difunctional (meth)acrylate, trifunctional (meth)acrylate-1, and trifunctional (meth)acrylate-2 used in Examples.
Difunctional (meth)acrylate: MIRAMER M2100 (manufactured by MIWON SPECIALTY CHEMICAL CO., LTD.)
Structural formula or compound name: bisphenol A (EO)₁₀ diacrylate
Trifunctional (meth)acrylate-1: MIRAMER M3130 (manufactured by MIWON SPECIALTY CHEMICAL CO., LTD.)
Structural formula or compound name: trimethylolpropane (EO)₃ triacrylate
Trifunctional (meth)acrylate-2: MIRAMER M3160 (manufactured by MIWON SPECIALTY CHEMICAL CO., LTD.)
Structural formula or compound name: trimethylolpropane (EO)₆ triacrylate

The content of the component (B) is preferably 0 mass % to 30 mass %, more preferably 0 mass % to 20 mass %, and particularly preferably 3 mass % to 15 mass %, based on the total solid content mass of the composition.

The content of the component (B) is preferably 0 mass % to 20 mass %, and more preferably 3 mass % to 15 mass %, based on the total solid content mass of the composition, from the viewpoint of sufficiently exhibiting the above-described specific indentation depth (hmax) at the maximum test force and elastic deformation power (nIT).

### (Component (C))

The component (C) is an initiator. A photopolymerization initiator is preferred.

Examples of the photopolymerization initiator include 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, thioxanthone and a thioxanthone derivative, 2,2′-dimethoxy-1,2-diphenylethan-1-one, diphenyl(2,4,6-trimethoxybenzoyl)phosphine oxide, 2,4,6-trimethylbenzoyldiphenylphosphine oxide, bis(2,4,6-trimethylbenzoyl)phenylphosphine oxide, 2-methyl-1-(4-methylthiophenyl)-2-morpholinopropan-1-one, and 2-benzyl-2-dimethylamino-1-(4-morpholinophenyl)-1-butanone.

Specific examples of the component (C) include initiator-1 to initiator-3.
Initiator-1: Runtecure 1108 (manufactured by Runtec Chemical Co., Ltd.)
Structural formula or compound name: 2,4,6-trimethylbenzoyldiphenylphosphine oxide
Initiator-2: Runtecure 1104 (manufactured by Runtec Chemical Co., Ltd.)
Structural formula or compound name: 1-hydroxycyclohexyl phenyl ketone
Initiator-3: benzophenone (manufactured by IGM Resins Inc.)
Structural formula or compound name: benzophenone

The content of the component (C) is preferably 0.1 mass % to 10 mass %, and more preferably 0.5 mass % to 5 mass %, based on the total solid content mass of the composition.

### (Component (D))

The component (D) is a surface conditioner. A silicon-based surface conditioner is preferred.

The component (D) has a function of imparting a slipping property.

Specific examples of the component (D) include a silicon-based surface conditioner: BYK series such as BYK-333 (manufactured by BYK-Chemie Japan K.K.).

The content of the component (D) is preferably 0.01 mass % to 3 mass %, and more preferably 0.2 mass % to 1.5 mass %, based on the total solid content mass of the composition, from the viewpoint of bleed-out resistance.

In addition to the above-described components, the composition of the present embodiment may also contain, if necessary, a phosphate ester, a silane coupling agent, a plasticizer, an antioxidant, a polymerization inhibitor, a thickener, a release agent, an antistatic agent, an ultraviolet stabilizer, an antifoaming agent, a solvent, a non-reactive urethane resin such as a non-reactive urethane polymer, a non-reactive acrylic resin, a non-reactive polyester resin, a pigment, a dye, or a diffusing agent.

Generally, the composition of the present embodiment is appropriately prepared such that the total amount of the essential components contained in the composition and the components forming a matrix of the prism sheet after curing other than the essential components is generally 90 mass % or more based on the total mass of the composition.

### <Phosphate Ester>

The phosphate ester according to the present embodiment is not particularly limited, and examples thereof include those having a polyester chain and those having a (meth)acryloyl group.

Examples of those having a polyester chain include DISPERBYK-110 and DISPERBYK-111 (manufactured by BYK-Chemie Japan K.K.).

Examples of those having a (meth)acryloyl group include a phosphate ester represented by the following structural formula (1). When the phosphate ester represented by the following structural formula (1) is used, the obtained inorganic fine particle dispersion has an excellent dispersion stability, the curing composition containing the inorganic fine particle dispersion has low viscosity, and a cured coating film having a high refractive index performance and excellent bleed-out resistance can be formed.

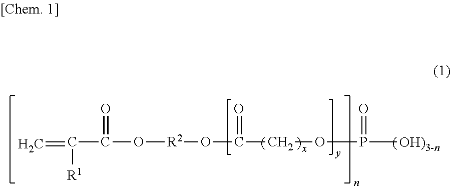

(In the formula, R¹ represents a hydrogen atom or a methyl group, and R² is an alkylene chain having 2 to 4 carbon atoms. In addition, x is an integer of 4 to 10, y is an integer of 1 or more, and n is an integer of 1 to 3).

In the phosphate ester compound represented by the structural formula (1), x in the formula is preferably 4 or 5, and y is preferably an integer of 2 to 7. When such a phosphate ester compound is used, the active energy ray curing composition to be obtained has low viscosity, and a cured coating film having a high refractive index performance and excellent bleed-out resistance can be formed. A dispersant represented by the structural formula (1) may be a mixture in which n in the formula is 1, 2, and/or 3.

The content of the phosphate ester compound in the active energy ray curing composition is more preferably in a range of 5 parts by mass to 40 parts by mass, and still more preferably in a range of 10 parts by mass to 25 parts by mass, based on 100 parts by mass of zirconia. When the content of the phosphate ester compound is in the range of 5 parts by mass to 40 parts by mass based on 100 parts by mass of zirconia, a cured coating film having a high refractive index performance and excellent bleed-out resistance can be formed.

### <Silane Coupling Agent>

Examples of the silane coupling agent according to the present embodiment include (meth)acryloyloxy-based silane coupling agents such as 3-(meth)acryloyloxypropyltrimethylsilane, 3-(meth)acryloyloxypropylmethyldimethoxysilane, 3-(meth)acryloyloxypropyltrimethoxysilane, 3-(meth)acryloyloxypropylmethyldiethoxysilane, and 3-(meth)acryloyloxypropyltriethoxysilane; vinyl-based silane coupling agents such as allyltrichlorosilane, allyltriethoxysilane, allyltrimethoxysilane, diethoxymethylvinylsilane, trichlorovinylsilane, vinyltrichlorosilane, vinyltrimethoxysilane, vinyltriethoxysilane, and vinyltris(2-methoxyethoxy)silane; epoxy-based silane coupling agents such as diethoxy(glycidyloxypropyl)methylsilane, 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane; styrene-based silane coupling agents such as p-styryltrimethoxysilane; amino-based silane coupling agents such as N-2(aminoethyl)3-aminopropylmethyldimethoxysilane, N-2(aminoethyl)3-aminopropyltrimethoxysilane, N-2(aminoethyl)3-aminopropyltriethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane; ureido-based silane coupling agents such as 3-ureidopropyltriethoxysilane; chloropropyl-based silane coupling agents such as 3-chloropropyltrimethoxysilane; mercapto-based silane coupling agents such as 3-mercaptopropylmethyldimethoxysilane and 3-mercaptopropyltrimethoxysilane; sulfide-based silane coupling agents such as bis(triethoxysilylpropyl)tetrasulfide; isocyanate-based silane coupling agents such as 3-isocyanatepropyltriethoxysilane; and aluminum-based silane coupling agents such as acetoalkoxyaluminum diisopropylate. These silane coupling agents may be used alone or in combination of two or more thereof. Among them, 3-(meth)acryloyloxypropyltrimethoxysilane is preferred because of good compatibility with the (meth)acryloyl group-containing compound (C) to be described later.

The amount of the silane coupling agent according to the present embodiment to be used is preferably in a range of 10 parts by mass to 30 parts by mass based on 100 parts by mass of zirconia since the obtained active energy ray curing composition has an excellent dispersion stability and a cured coating film having low viscosity, a high refractive index performance, and excellent bleed-out resistance can be formed.

### [Transparent Substrate Layer]

The transparent substrate layer 4 according to the present embodiment is a substrate of the prism sheet 10, and is not particularly limited. A related art well-known transparent substrate used in a prism sheet can be used. As the transparent substrate layer, for example, those described in PTL 2 can be used.

The material and thickness of the transparent substrate layer 4 according to the present embodiment may be appropriately selected in consideration of required suitability such as desired transparency and mechanical strength.

The transparent substrate layer 4 according to the present embodiment may be a resin substrate or a glass substrate.

Preferred examples of a resin material of a transparent film include a (meth)acrylate compound, a polycarbonate resin, a vinyl chloride resin, a polymethacrylimide resin, a polyimide resin, a polyester resin, a cycloolefin polymer (COP) resin, a cycloolefin copolymer (COC) resin, and a triacetylcellulose (TAC) resin.

The transparent substrate layer 4 according to the present embodiment may have an elongated shape or a sheet shape having a predetermined size.

The thickness of the transparent substrate layer 4 according to the present embodiment is generally preferably 50 μm to 500 μm, but is not limited thereto.

The light transmittance of the transparent substrate layer 4 according to the present embodiment is ideally 100% for front installation of the display, and the transmittance is preferably 85% or more.

If necessary, the surface of the transparent substrate layer 4 according to the present embodiment may be subjected to a related art well-known matte treatment (formation of micro light-diffusing convexo-concave), an antistatic treatment, an antireflection treatment, or the like. In addition, the matte treatment, the antistatic treatment, the antireflection treatment, or the like may be performed between the transparent resin and the substrate, or these may be freely combined and used.

### [Method for Producing Prism Sheet]

A method for producing the prism sheet 10 of the present embodiment is not particularly limited as long as the above-described specific indentation depth or the above-described elastic deformation power can be obtained, and a related art well-known method can be used.

For example, as shown in FIG. 2 in Patent Literature (JP2009-37204A), the composition is put into a mold having a desired unit concave-convex shape, a transparent substrate layer is stacked thereon, the transparent substrate layer is press-bonded to the composition by using a laminator or the like, and the composition is cured with ultraviolet rays or the like to form a unit concave-convex shape. Next, the mold having the unit concave-convex shape is peeled off or removed to obtain a prism sheet including an optical function exhibiting portion having a desired concave-convex shape on the transparent substrate layer.

### (Active Energy Ray Curing Composition for Prism Sheet)

The active energy ray curing composition for a prism sheet of the present embodiment is an active energy ray curing composition which contains zirconia and a (meth)acrylate compound and is used for producing the above-described prism sheet of the present embodiment.

A standard prism sheet made of a cured product of the active energy ray curing composition for a prism sheet of the present embodiment has an indentation depth (hmax) of 8 μm or more at a maximum test force and an elastic deformation power (nIT) of 50% or more.

The standard prism sheet according to the present embodiment is the same as the standard prism sheet described in the prism sheet of the present embodiment.

Measurement conditions for the indentation depth (hmax) at the maximum test force and the elastic deformation power (nIT) according to the present embodiment are the same as the measurement conditions described in the prism sheet of the present embodiment.

In a tearing test of a test piece formed of the cured product of the active energy ray curing composition for a prism sheet of the present embodiment, a maximum point displacement is preferably 2.1% or more.

Measurement conditions for the tearing test according to the present embodiment are the same as the measurement conditions described in the prism sheet of the present embodiment.

The active energy ray curing composition for a prism sheet of the present embodiment preferably contains a surface conditioner, more preferably contains the surface conditioner in a range of 0.01 parts by mass to 3 parts by mass, and still more preferably contains the surface conditioner in a range of 0.2 parts by mass to 1.5 parts by mass. The surface conditioner according to the present embodiment is the same as the surface conditioner described in the prism sheet of the present embodiment.

### Example

The present invention will be described in detail below with reference to Examples, but the present invention is not limited thereto.

### (Raw Material)

Zirconia: UEP-100, manufactured by Daiichi Kigenso Kagaku Kogyo Co., Ltd.
Titania: P25, manufactured by Nippon Aerosil Co., Ltd.
Phosphate ester: DISPERBYK-111, manufactured by BYK-Chemie Japan K.K. silane coupling agent: KBM-503, manufactured by Shin-Etsu Chemical Co., Ltd.
Monofunctional (meth)acrylate-1: KOMERATE A011, manufactured by Green Chemical Co., Ltd.
Monofunctional (meth)acrylate-2: Photomer 4035, manufactured by IGM Resins Inc.
Monofunctional (meth)acrylate-3: KOMERATE A008, manufactured by Green Chemical Co., Ltd.
Monofunctional (meth)acrylate-4: MIRAMER M1192, manufactured by MIWON SPECIALTY CHEMICAL CO., LTD.
Monofunctional (meth)acrylate-5: MIRAMER M142, manufactured by MIWON SPECIALTY CHEMICAL CO., LTD.
Monofunctional (meth)acrylate-6: MIRAMER M144, manufactured by MIWON SPECIALTY CHEMICAL CO., LTD.
Difunctional (meth)acrylate: MIRAMER M2100, manufactured by MIWON SPECIALTY CHEMICAL CO., LTD.
Trifunctional (meth)acrylate-1: MIRAMER M3130, manufactured by MIWON SPECIALTY CHEMICAL CO., LTD.
Trifunctional (meth)acrylate-2: MIRAMER M3160, manufactured by MIWON SPECIALTY CHEMICAL CO., LTD.
Phthalate-based plasticizer: diethylene glycol dibenzoate, manufactured by Tokyo Chemical Industry Co., Ltd.
Initiator-1: Runtecure 1108, manufactured by Runtec Chemical Co., Ltd.
Initiator-2: Runtecure 1104, manufactured by Runtec Chemical Co., Ltd.
Initiator-3: benzophenone, manufactured by IGM Resins Inc.
Silicon-based surface conditioner: BYK-333, manufactured by BYK-Chemie Japan K.K.
HALS: TINUVIN 292, manufactured by BASF Japan

### <Indentation Test>

A test piece of an indentation test was a prism sheet obtained in each of Examples and Comparative Examples to be described later.

FIG. 3 is a schematic view showing a cross section of a flat indenter used in the present embodiment (an upper side is a measurement surface). An indentation depth (hmax) at a maximum test force and an elastic deformation power (nIT) were measured using a microhardness tester (product name HM2000) manufactured by Fischer Instruments K.K. according to ISO 14577-1, except that an indenter was a diamond flat indenter instead of a diamond square pyramid indenter.

### Test Conditions:

Flat indenter, flat size: 100 μm×100 μm
20 mN to 60 mN per second
Maximum compressive force: 500 mN
Stop time for maximum compressive force: 5 seconds to 10 seconds
F 500 mN/10 s
C 5.0 s
R 0.1 mN/10 s
C2 10.0 s

### <Abrasion Resistance>

Abrasion resistance of each of the prism sheets in Examples and Comparative Examples was evaluated. The prism sheet was attached to a movable platen manufactured by Imoto Machinery Co., Ltd. with a top portion of the sheet facing a load side, and a PET-based diffusion film was attached to a holder having a diameter of 1 cm as an abrasive on the load side, such that a substrate layer of the diffusion film rubbed against the top portion of the prism sheet. The evaluation was performed in a room at 23° C. (humidity: 50%). A load of 300 g was applied to a load portion, and an abrasion resistance tester was operated to move the movable platen in one direction (movement speed: 4 m/min, movement distance: 10 cm, number of times of reciprocation: 40), and a degree of band-like scratch after that was evaluated visually. The criteria are as follows.

The determination standard is as follows.
A: No noticeable scratch is visible.
B: A thin and fine scratch is visible.
C: A moderate scratch is visible.
D: A dark and thick scratch is visible.

### <Liquid Refractive Index>

A liquid refractive index was evaluated by measuring a refractive index at a temperature of 25° C. and a wavelength of 589 nm using a multi-wavelength Abbe refractometer DR-M4 (manufactured by Atago Co., Ltd.).

### <Viscosity>

Viscosity was evaluated by measuring viscosity at a temperature of 25° C. using an E-type rotational viscometer (TVE-25H, manufactured by Toki Sangyo Co., Ltd.).

### (Evaluation)

### <Tearing Test>

A test piece for the tearing test is a cured product of the active energy ray curing composition of the present embodiment. Curing conditions were the same as those in Example 1 to be described later.

The tearing test was performed according to JIS-K-7128-3 under the following measurement conditions:
shape of the test piece: a right-angle tearing test piece according to JIS-K-7128-3
thickness of the test piece: 200 μm±50 μm (value measured for each test piece)
preparation of the test piece: prepared by punching
distance between grips: 56 mm
test environment: 23° C.×50% RH
test speed: 500 mm/min.

### Preparation Example 1

51.2 parts by mass of UEP-100 as zirconia, 7.7 parts by mass of DISPERBYK-111 as a phosphate ester, 5.1 parts by mass of KBM-503 as a silane coupling agent, and 110.1 parts by mass of methyl ethyl ketone (hereinafter, abbreviated as “MEK”) were mixed, followed by stirring for 30 minutes with a dispersion stirrer to perform coarse dispersion. Next, the obtained mixed liquid was subjected to a dispersion treatment using zirconia beads having a particle diameter of 100 μm in a media type wet disperser (“STAR MILL LMZ-015” manufactured by Ashizawa Finetech Co., Ltd.). While checking a particle size during the process, a dispersion treatment was performed for a residence time of 100 minutes to obtain an inorganic fine particle dispersion.

To the inorganic fine particle dispersion, 24.0 parts by mass of Photomer 4035 as a monofunctional (meth)acrylate and 10.0 parts by mass of MIRAMER M2100 as a difunctional (meth)acrylate were added, and volatile components were removed under reduced pressure while heating with an evaporator. Further, 0.7 parts by mass of Runtecure 1108 and 0.7 parts by mass of Runtecure 1104 as an initiator, and 0.5 parts by mass of BYK-333 as a silicon-based surface conditioner were added to prepare an active energy ray curing composition P1 (composition P1) of the present embodiment. A liquid refractive index and viscosity of the composition P1 were evaluated. In addition, a tearing test of the cured product of the composition P1 was performed. The results are shown in Table 1.

### (Preparation Examples 2 to 6 and Comparative Preparation Examples 1 to 11)

In each Preparation Example, compositions P2 to P6 and cP1 to cP11 in Preparation Examples 2 to 6 and Comparative Preparation Examples 1 to 11, respectively, were prepared in the same manner as in Preparation Example 1 except that components and composition ratios shown in Table 1 were used. A liquid refractive index and viscosity of each composition were evaluated. In addition, a tearing test of the cured product of each composition was performed. The results are shown in Table 1.

TABLE 1

| | | Preparation Example | | | | | | Comparative Preparation Example | | |
|---|---|---|---|---|---|---|---|---|---|---|
| Unit: parts by mass | | 1 | 2 | 3 | 4 | 5 | 6 | 1 | 2 | 3 |
| Active energy ray curing composition No. | | P1 | P2 | P3 | P4 | P5 | P6 | cP1 | cP2 | cP3 |
| Zirconia | UEP-100 | 51.2 | 43.6 | 44.8 | 49.8 | 51.5 | 46.2 | 49.7 | 44.8 | 45.1 |
| Titania | P25 | | | | | | | | | |
| Phosphate ester | DISPERBYK-111 | 7.7 | 6.5 | 6.7 | 7.5 | 7.7 | 9.2 | 7.5 | 6.7 | 6.8 |
| Silane coupling agent | KBM-503 | 5.1 | 4.4 | 4.5 | 5.0 | 5.2 | 6.9 | 5.0 | 4.5 | 4.5 |
| Monofunctional | KOMERATE A011 | | | | | | | 8.8 | | |
| (meth)acrylate | Photomer 4035 | 24.0 | | 11.2 | 27.7 | 24.1 | | 17.7 | 11.2 | 11.3 |
| | KOMERATE A008 | | 24.3 | | | | 14.4 | | | |
| | MIRAMER M1192 | | 4.5 | 16.8 | | | 7.3 | | 16.8 | 16.9 |
| | MIRAMER M142 | | | | | | | | 13.9 | 14.0 |
| | MIRAMER M144 | | | 13.9 | | | | | | |
| Difunctional | MIRAMER M2100 | 10.0 | 13.9 | | | 10.0 | 14.0 | 6.9 | | |
| (meth)acrylate | | | | | | | | | | |
| Trifunctional | MIRAMER M3130 | | | | | | | 2.9 | | |
| (meth)acrylate | MIRAMER M3160 | | | | 3.0 | | | | | |
| Phthalate-based | Diethylene glycol | | | | 2.3 | | | | | |
| plasticizer | dibenzoate | | | | | | | | | |
| Initiator | Runtecure 1108 | 0.7 | 1.0 | 0.7 | 0.7 | 0.7 | 1.0 | 1.5 | 0.7 | 0.8 |
| | Runtecure 1104 | 0.7 | 1.0 | 0.7 | 0.7 | 0.7 | 1.0 | | 0.7 | 0.8 |
| | Benzophenone | | | | 2.8 | | | | | |
| Silicon-based | BYK-333 | 0.5 | 1.0 | 0.5 | 0.5 | | | | 0.5 | |
| surface conditioner | | | | | | | | | | |
| HALS | TINUVIN 292 | | | | | | | | | |
| Liquid refractive index | | 1.62 | 1.62 | 1.62 | 1.62 | 1.62 | 1.62 | 1.62 | 1.62 | 1.62 |
| Viscosity (mPa · s) | | 1600 | 800 | 300 | 400 | 1600 | 1300 | 1500 | 300 | 300 |
| Tearing test result | Maximum | 3.5 | 4.2 | 4.0 | 3.5 | 3.2 | 2.5 | 2.0 | 4.5 | 3.8 |
| | point_displacement | | | | | | | | | |
| | (strain) (%) | | | | | | | | | |

| | | Comparative Preparation Example | | | | | | | |
|---|---|---|---|---|---|---|---|---|---|
| Unit: parts by mass | | 4 | 5 | 6 | 7 | 8 | 9 | 10 | 11 |
| Active energy ray curing composition No. | | cP4 | cP5 | cP6 | cP7 | cP8 | cP9 | cP10 | cP11 |
| Zirconia | UEP-100 | 42.1 | 51.2 | 39.8 | 51.5 | 40.0 | | 31.0 | |
| Titania | P25 | | | | | | 31.0 | | 35.0 |
| Phosphate ester | DISPERBYK-111 | 6.3 | 7.7 | 6.0 | 7.7 | 6.0 | 4.7 | 4.7 | 5.3 |
| Silane coupling agent | KBM-503 | 4.2 | 5.1 | 4.0 | 5.2 | 4.0 | 3.1 | 3.1 | 3.5 |
| Monofunctional | KOMERATE A011 | | | | | | | | |
| (meth)acrylate | Photomer 4035 | 6.1 | 34.0 | | 34.1 | | 23.3 | 23.3 | 20.0 |
| | KOMERATE A008 | | | | | | | | |
| | MIRAMER M1192 | 24.4 | | 33.3 | | 33.5 | | | |
| | MIRAMER M142 | | | | | | | | |
| | MIRAMER M144 | | | | | | | | |
| Difunctional | MIRAMER M2100 | 13.9 | | 14.9 | | 15.0 | 33.0 | 33.0 | 35.0 |
| (meth)acrylate | | | | | | | | | |
| Trifunctional | MIRAMER M3130 | | | | | | | | |
| (meth)acrylate | MIRAMER M3160 | | | | | | | | |
| Phthalate-based | Diethylene glycol | | | | | | | | |
| plasticizer | dibenzoate | | | | | | | | |
| Initiator | Runtecure 1108 | 1.0 | 0.7 | 0.7 | 0.7 | 0.7 | 3.0 | 3.0 | 1.3 |
| | Runtecure 1104 | 1.0 | 0.7 | 0.7 | 0.7 | 0.7 | | | |
| | Benzophenone | | | | | | | | |
| Silicon-based | BYK-333 | 1.0 | 0.5 | 0.5 | | | | | |
| surface conditioner | | | | | | | | | |
| HALS | TINUVIN 292 | | | | | | 2.0 | 2.0 | |
| Liquid refractive index | | 1.62 | 1.62 | 1.62 | 1.62 | 1.62 | 1.59 | 1.57 | 1.6 |
| Viscosity (mPa · s) | | 600 | 800 | 600 | 800 | 600 | 400 | 400 | 600 |
| Tearing test result | Maximum | 1.6 | 4.0 | 1.2 | 4.4 | 1.6 | 5.0 | 4.5 | 3.8 |
| | point_displacement | | | | | | | | |
| | (strain) (%) | | | | | | | | |

### Example 1

The above-described composition P1 prepared in Preparation Example 1 was added dropwise to a prism mold (not shown) capable of forming a concave-convex shape of linearly arranged unit prisms as shown in FIG. 1. Thereafter, polyethylene terephthalate (PET) having a thickness of 125 μm (product name “A4300” manufactured by Toyobo Co., Ltd.) was stacked as a transparent substrate layer, and an entire surface of the PET substrate was press-bonded to the composition P1 by a laminator.

Next, a prism portion having a large number of unit prisms was cured under the following curing conditions to be integrated with the PET substrate.

### Curing Conditions:

irradiation light source: ultraviolet ray
irradiation device: high-pressure mercury lamp (manufactured by GS Yuasa Lighting Service Co., Ltd.)
irradiation intensity: 780 mJ/cm².
Thereafter, the prism type was peeled off to obtain a prism sheet S1.

Here, a shape of the unit prism was an isosceles triangular prism shape having a height of 25 μm, a base of 50 μm, and an apex angle of 90° in a cross section in a thickness direction. Then, in the micro concave-convex structure layer, a large number of plurality of unit prisms are adjacently arranged with an array period of 50 μm in a direction perpendicular to ridge lines such that the ridge lines of the respective unit prisms are balanced with each other.

An indentation test and an abrasion resistance test for the prism sheet S1 were performed. The results are shown in Table 2.

### Examples 2 to 6 and Comparative Examples 1 to 11

Prism sheets S1 to S6 and cS1 to cS11 were obtained in the same manner as in Example 1 except that the composition P1 in Example 1 was changed to the compositions P2 to P6 and cP1 to cP11, respectively, as shown in Table 1.

An indentation test and an abrasion resistance test for each prism sheet were performed. The results are shown in Table 2.

TABLE 2

| | | Example | | | | | | Comparative Example | | | | | | | | | | |
|---|---|---|---|---|---|---|---|---|---|---|---|---|---|---|---|---|---|---|
| Unit: parts by mass | | 1 | 2 | 3 | 4 | 5 | 6 | 1 | 2 | 3 | 4 | 5 | 6 | 7 | 8 | 9 | 10 | 11 |
| Active energy ray | | P1 | P2 | P3 | P4 | P5 | P6 | cP1 | cP2 | cP3 | cP4 | cP5 | cP6 | cP7 | cP8 | cP9 | cP10 | cP11 |
| curing composition No. | | | | | | | | | | | | | | | | | | |
| Indentation | nIT (%) | 54.3 | 55.4 | 54.2 | 56.2 | 54.8 | 51.2 | 42.2 | 46.7 | 46.7 | 34.0 | 45.5 | 35.7 | 45.5 | 35.7 | 55.0 | 54.0 | 54.0 |
| test results | hmax u (μm) | 8.7 | 9.9 | 9.4 | 9.2 | 8.9 | 8.5 | 8.1 | 9.1 | 9.1 | 7.9 | 9.6 | 6.7 | 9.6 | 6.7 | 11.0 | 10.0 | 9.0 |

| | | | | | | | | | | | | | | | | | |
|---|---|---|---|---|---|---|---|---|---|---|---|---|---|---|---|---|---|
| Abrasion resistance | A | A | B | B | C | C | D | D | D | D | D | D | D | D | B | B | C |

### (Discussion)

As shown in Tables 1 and 2, the prism sheet containing 40 mass % or more of zirconia as inorganic nanoparticles, and having 50% or more of nIT and 8 μm or more of hmax could achieve both high refractive index and abrasion resistance. Generally, when inorganic nanoparticles are added, the flexibility decreases and the crosslinking density of the resin decreases, and thus the abrasion resistance deteriorates. However, when the nIT was 50% or more and the hmax was 8 μm or more, the abrasion resistance was good. This is considered to be because in the prism sheet having a large hmax, a prism top portion is deformed by a load at the time of the abrasion resistance test, and a contact area with an abrasive cloth increases, whereby the load is dispersed. In addition, in a composition having a large nIT, the power of elastic deformation is greater than that of plastic deformation, so that even when the composition is deformed by applying a load, the composition returns to an original shape at the time of unloading.

The prism sheet made of a composition having a maximum point displacement of 2.1% or more in the tearing test of the cured product exhibited good abrasion resistance. This is considered to be because when the maximum point displacement in the tearing test is large, an apex of the prism is deformed without being chipped or broken even when the apex of the prism is stretched by a frictional force during the abrasion resistance test.

The abrasion resistance of the prism sheet can be further improved by adding a silicon-based surface conditioner to impart a slipping property.

### REFERENCE SIGNS LIST

2: Micro concave-convex structure layer (prism layer)
2a: Unit concave-convex structure (unit prism)
4: Transparent substrate layer
10: Prism sheet
24a: Apex angle
24b: Bottom angle
24: Concave portion
50: Flat indenter
52: Measurement surface

1. A prism sheet comprising:
a micro concave-convex structure layer which is a cured product of an active energy ray curing composition; and
a transparent substrate layer, wherein
the active energy ray curing composition contains 40 mass % or more of inorganic nanoparticles,
the micro concave-convex structure layer has a micro concave-convex structure with a period of 10 μm to 100 μm on a surface,
the micro concave-convex structure layer has an indentation depth (hmax) of 8 μm or more at a maximum test force and an elastic deformation power (nIT) of 50% or more, and
the indentation depth (hmax) at the maximum test force and the elastic deformation power (nIT) are obtained under the following measurement conditions:
indenter: 100 μm×100 μm flat indenter
compressive force per second of flat indenter: 20 mN to 60 mN maximum compressive force: 500 mN
stop time at maximum compressive force: 5 seconds to 10 seconds.

2. The prism sheet according to claim 1, wherein
a maximum point displacement is 2.1% or more in a tearing test of a test piece formed of the cured product of the active energy ray curing composition, and
the tearing test is performed according to JIS-K-7128-3 under the following measurement conditions:
shape of the test piece: a right-angle tearing test piece according to JIS-K-7128-3
thickness of the test piece: 200 μm±50 μm (value measured for each test piece)
preparation of the test piece: prepared by punching
distance between grips: 56 mm
test environment: 23° C.×50% RH
test speed: 500 mm/min.

3. The prism sheet according to claim 1, wherein
the inorganic nanoparticles are zirconia.

4. The prism sheet according to claim 1, wherein
the active energy ray curing composition contains a (meth)acrylate compound.

5. The prism sheet according to claim 1, wherein
the active energy ray curing composition contains a surface conditioner in a range of 0.1 parts by mass to 1.5 parts by mass in the composition.

6. The prism sheet according to claim 5, wherein
the surface conditioner contains silicon.

7. An active energy ray curing composition for a prism sheet, the composition comprising:
inorganic nanoparticles; and
a (meth)acrylate compound, wherein
the active energy ray curing composition for a prism sheet contains 40 mass % or more of the inorganic nanoparticles,
a standard prism sheet made of a cured product of the active energy ray curing composition for a prism sheet has an indentation depth (hmax) of 8 μm or more at a maximum test force and an elastic deformation power (nIT) of 50% or more,
the standard prism sheet includes a transparent substrate layer and a micro concave-convex structure layer,
the transparent substrate layer is polyethylene terephthalate having a thickness of 125 μm,
the micro concave-convex structure layer has a micro concave-convex structure with a period of 50 μm on a surface of the transparent substrate layer, a unit structure of the micro concave-convex structure constitutes a unit prism, and a shape of the unit prism is an isosceles triangular prism shape having a height of 25 μm, a base of 50 μm, and an apex angle of 90° in a cross section in a thickness direction,
for the unit prism, a large number of plurality of unit prisms are adjacently arranged with an array period of 50 μm in a direction perpendicular to ridge lines such that the ridge lines of the respective unit prisms are balanced with each other in a plan view of the prism sheet, and
the indentation depth (hmax) at the maximum test force and the elastic deformation power (nIT) are obtained under the following measurement conditions:
indenter: 100 μm×100 μm flat indenter
compressive force per second of flat indenter: 20 mN to 60 mN maximum compressive force: 500 mN
stop time at maximum compressive force: 5 seconds to 10 seconds.

8. The active energy ray curing composition for a prism sheet according to claim 7, wherein
a maximum point displacement is 2.1% or more in a tearing test of a test piece formed of the cured product of the active energy ray curing composition for a prism sheet, and
the tearing test is performed according to JIS-K-7128-3 under the following measurement conditions:
shape of the test piece: a right-angle tearing test piece according to JIS-K-7128-3
thickness of the test piece: 200 μm±50 μm (value measured for each test piece)
preparation of the test piece: prepared by punching
distance between grips: 56 mm
test environment: 23° C.×50% RH
test speed: 500 mm/min.

9. The active energy ray curing composition for a prism sheet according to claim 7, wherein
the inorganic nanoparticles are zirconia.

10. The active energy ray curing composition for a prism sheet according to claim 7, further comprising:
a surface conditioner in a range of 0.1 parts by mass to 1.5 parts by mass.

11. The prism sheet according to claim 2, wherein
the inorganic nanoparticles are zirconia.

12. The prism sheet according to claim 2, wherein
the active energy ray curing composition contains a (meth)acrylate compound.

13. The prism sheet according to claim 2, wherein
the active energy ray curing composition contains a surface conditioner in a range of 0.1 parts by mass to 1.5 parts by mass in the composition.

14. The prism sheet according to claim 13, wherein
the surface conditioner contains silicon.

15. The active energy ray curing composition for a prism sheet according to claim 8, wherein
the inorganic nanoparticles are zirconia.

16. The active energy ray curing composition for a prism sheet according to claim 8, further comprising:
a surface conditioner in a range of 0.1 parts by mass to 1.5 parts by mass.
